(19) United States
(12) Patent Application Publication
(10) Pub. No.: US 2020/0323048 A1
(43) Pub. Date: Oct. 8, 2020

(54) INDUCTION HEATING APPARATUS

(71) Applicant: Samsung Electronics Co., Ltd., Suwon-si (KR)

(72) Inventors: Hong-Joo KANG, Suwon-si (KR); Changsun YUN, Suwon-si (KR); Hyunkwan LEE, Suwon-si (KR)

(21) Appl. No.: 16/838,943

(22) Filed: Apr. 2, 2020

(30) Foreign Application Priority Data
Apr. 2, 2019 (KR) 10-2019-0038454

(51) Int. Cl. H05B 6/12; H05B 6/04; H05B 6/06

(52) U.S. Cl. CPC H05B 6/1254; H05B 6/04; H05B 2213/07; H05B 6/1272; H05B 2213/05; H05B 6/065

(57) ABSTRACT

An induction heating apparatus including a plurality of inverters configured with a plurality of types of switching topologies on a printed board assembly (PBA). The induction heating apparatus includes a cooking plate; a plurality of induction heating coils installed below the cooking plate and configured to generate a magnetic field; a plurality of driving circuits respectively connected to the plurality of induction heating coils and configured to supply a driving current to the corresponding induction heating coils; and a rectifier circuit configured to rectify AC power to supply the rectified AC power to the plurality of driving circuits. Each of the plurality of driving circuits may be connected in parallel to an output terminal of the rectifier circuit. The plurality of driving circuits may include at least one first driving circuit comprising one switching element and at least one second driving circuit comprising a plurality of the switching elements.

### CROSS-REFERENCE TO RELATED APPLICATION

This application is based on and claims priority under 35 U.S.C. § 119 to Korean Patent Application No. 10-2019-0038454 filed on Apr. 2, 2019 in the Korean Intellectual Property Office, the disclosure of which is incorporated by reference in its entirety.

### BACKGROUND

### 1. Field

The disclosure relates to an induction heating apparatus including a plurality of coils.

### 2. Description of Related Art

Generally, an induction heating apparatus is a cooking appliance for heating food using the principle of induction heating. The induction heating apparatus includes a cooking plate on which a cooking vessel is placed, and a coil to generate a magnetic field when a current is applied thereto.

If the current is applied to the coil to generate a magnetic field, a secondary current is induced to the cooking vessel, and Joule heat is generated due to resistance components of the cooking vessel. Accordingly, the cooking vessel is heated by such high-frequency current so that food contained in the cooking vessel is cooked.

When the cooking vessel is placed on the induction heating apparatus, the cooking vessel itself acts as a heating source. Accordingly, the induction heating apparatus has some advantages in that the cooking vessel can be more rapidly heated than with a gas range or a kerosene cooking stove in which a fossil fuel is burned to heat a cooking container using combustion heat and a harmful gas is not generated and there is no risk of fire.

### SUMMARY

Therefore, it is an aspect of the disclosure to provide an induction heating apparatus including a plurality of inverters configured with a plurality of types of switching topologies on a printed board assembly (PBA).

Additional aspects of the disclosure will be set forth in part in the description which follows and, in part, will be obvious from the description, or may be learned by practice of the disclosure.

In accordance with an aspect of the disclosure, an induction heating apparatus includes a cooking plate; a plurality of induction heating coils installed below the cooking plate and configured to generate a magnetic field; a plurality of driving circuits respectively connected to the plurality of induction heating coils and configured to supply a driving current to the corresponding induction heating coils; and a rectifier circuit configured to rectify AC power to supply the rectified AC power to the plurality of driving circuits. Each of the plurality of driving circuits may be connected in parallel to an output terminal of the rectifier circuit. The plurality of driving circuits may include at least one first driving circuit comprising one switching element and at least one second driving circuit comprising a plurality of the switching elements.

The first driving circuit may include one first capacitor connected in parallel with the induction heating coil, and a first switching element provided between a first capacitor side node and a ground side node and connected in series with the first capacitor.

The second driving circuit may correspond to a half bridge type circuit including a pair of the switching elements connected in series with each other and a pair of capacitors connected in series with each other, or a full bridge type circuit including a pair of the switching elements connected in series with each other and the other of the pair of the switching elements connected in series with each other.

When the second driving circuit corresponds to the half bridge driving circuit, the pair of switching elements may be connected in parallel with the pair of capacitors, and one end of the induction heating coil may be connected to a node to which the pair of switching elements are connected in series and the other end of the induction heating coil may be connected to a node to which the pair of capacitors are connected in series.

When the second driving circuit corresponds to the full bridge driving circuit, the pair of switching elements may be connected in parallel with the other pair of switching elements, and one end of the induction heating coil may be connected to a node to which the pair of switching elements are connected in series and the other end of the induction heating coil may be connected to a node to which the other pair of capacitors are connected in series.

Each of the plurality of driving circuits may include a smoothing circuit configured to uniformly maintain the power rectified from the rectifier circuit.

The induction heating apparatus may further include a power supply circuit configured to receive the AC power from an external power source.

The induction heating apparatus may further include an electromagnetic interference (EMI) filter provided between the power supply circuit and the rectifier circuit and configured to block high frequency noise included in the AC power.

The induction heating apparatus may further include a user interface configured to receive information about an output of the induction heating apparatus from a user.

The induction heating apparatus may further include at least one processor configured to determine a magnitude of an AC driving current transmitted to at least one of the plurality of driving circuits based on the information about the output of the induction heating apparatus, to determine a switching cycle of the switching element included in the driving circuit based on the determined magnitude of the AC driving current, and to open and close the switching element based on the determined switching cycle.

The induction heating apparatus may further include a first temperature sensor configured to detect a temperature of a cooking vessel placed on the cooking plate; and a first temperature detecting circuit configured to transmit an output of the first temperature sensor to the at least one processor.

When the temperature of the cooking vessel exceeds a predetermined temperature, the at least one processor may be configured to control the plurality of driving circuits in a direction of reducing the magnitude of the AC driving current supplied to the plurality of induction heating coils.

The induction heating apparatus may further include a heat sink provided in contact with at least one of the rectifier circuit or the driving circuits.

The induction heating apparatus may further include a second temperature sensor configured to detect a temperature of the heat sink; and a second temperature detecting circuit configured to transmit an output of the second temperature sensor to the at least one processor.

When the temperature of the heat sink exceeds a predetermined temperature, the at least one processor may be configured to control the plurality of driving circuits in a direction of reducing the magnitude of the AC driving current supplied to the plurality of induction heating coils.

The induction heating apparatus may further include a vessel sensor configured to detect a cooking vessel placed on the cooking plate; and a vessel detecting circuit configured to transmit an output of the vessel sensor to the at least one processor.

Each of the plurality of driving circuits may further include a current detecting circuit configured to detect the magnitude of the AC driving current supplied to the induction heating coil.

The at least one processor may be configured to determine whether the cooking vessel is placed on the induction heating coil corresponding to each of the plurality of driving circuits based on the output value received from at least one of the vessel detecting circuit and the current detecting circuit.

The at least one processor may be configured to determine whether the cooking vessel is placed on the induction heating coil corresponding to each of the plurality of driving circuits by comparing a current value detected from the current detecting circuit of each of the plurality of driving circuits with a predetermined reference current value.

When the cooking vessel is placed on the induction heating coil selected by the user through the user interface, the at least one processor may be configured to control the driving circuit corresponding to the selected induction heating coil to supply the AC driving current to the selected induction heating coil.

When the cooking vessel is placed on the induction heating coil selected by the user through the user interface, the at least one processor may be configured to control the driving circuit corresponding to the selected induction heating coil to supply the AC driving current to the selected induction heating coil.

When the cooking vessel is not placed on the induction heating coil selected by the user through the user interface, the at least one processor may control the user interface to output a message indicating that the cooking vessel is not detected.

In accordance with another aspect of the disclosure, an induction heating apparatus includes a cooking plate; a plurality of induction heating coils installed below the cooking plate and configured to generate a magnetic field; a plurality of driving circuits respectively connected to the plurality of induction heating coils and configured to supply a driving current to the corresponding induction heating coils; and a rectifier circuit configured to rectify AC power to supply the rectified AC power to the plurality of driving circuits. Each of the plurality of driving circuits may be connected in parallel to an output terminal of the rectifier circuit. The plurality of driving circuits may include a first driving circuit configured to supply a driving current to a first induction heating coil of the plurality of induction heating coils including one switching element; a second driving circuit configured to supply the driving current to a second induction heating coil of the plurality of induction heating coils including a plurality of the switching elements; and a third driving circuit configured to supply the driving current to a third induction heating coil of the plurality of induction heating coils including at least one of the switching elements.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an external view of an induction heating apparatus according to an embodiment of the disclosure;

FIG. 2 is a view illustrating an inside of an induction heating apparatus according to an embodiment of the disclosure;

FIG. 3 is a view illustrating a principle of heating a cooking vessel by an induction heating apparatus according to an embodiment of the disclosure;

FIG. 4 is a control block diagram of an induction heating apparatus according to an embodiment of the disclosure;

FIG. 5 is a view illustrating an induction heating coil, a vessel sensor, and a temperature sensor included in an induction heating apparatus according to an embodiment of the disclosure;

FIG. 6 is a view illustrating an example of an arrangement of a printed board assembly (PBA) included in an induction heating apparatus according to an embodiment of the disclosure;

FIG. 7 is an example of a circuit diagram of an induction heating apparatus according to an embodiment of the disclosure;

FIG. 8 is a view illustrating a first inverter circuit of a first driving circuit included in an induction heating apparatus according to an embodiment of the disclosure;

FIGS. 9 and 10 are views illustrating current flow when a second inverter circuit of a second driving circuit according to an embodiment of the disclosure is a half bridge;

FIGS. 11 and 12 are views illustrating current flow when a second inverter circuit of a second driving circuit according to an embodiment of the disclosure is a full bridge; and

FIGS. 13 and 14 are views illustrating a magnitude of a current of an induction heating coil according to opening and closing periods of a second driving circuit included in an induction heating apparatus of the disclosure.

### DETAILED DESCRIPTION

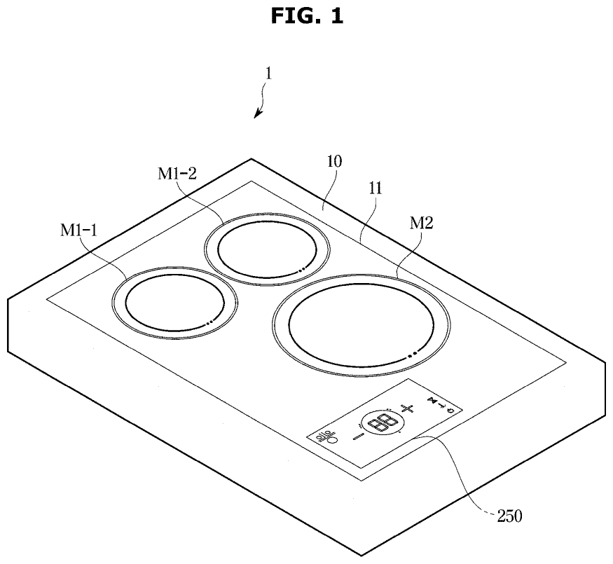

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments described herein and configurations illustrated in the accompanying drawings are only certain examples of the disclosure, and various modifications may be made at the time of filing of the present application to replace the embodiments and drawings of the present specification.

It will be understood that when a component is referred to as being “connected” to another component, it can be directly or indirectly connected to the other component. When a component is indirectly connected to another component, it may be connected to the other component through a wireless communication network.

In addition, the terms used herein are intended to only describe certain embodiments, and shall by no means restrict and/or limit the disclosure. It is to be understood that the singular forms “a,” “an,” and “the” include plural referents unless the context clearly dictates otherwise. In the present specification, the terms such as “comprising,” “having” or “including” are intended to designate the presence of characteristics, numbers, steps, operations, elements, parts or combinations thereof, and shall not be construed to preclude any possibility of the presence or addition of one or more other characteristics, numbers, steps, operations, elements, parts or combinations thereof.

In addition, although the terms including ordinal numbers such as “first” or “second” may be used herein to describe various elements, the elements should not be limited by such terms. The terms are used only for the purpose of distinguishing one component from another. For example, without departing from the scope of the disclosure, a first component may be referred to as a second component, and similarly, the second component may also be referred to as the first component.

As used herein, the terms “portion,” “unit,” “block,” “member,” or “module” refer to a unit that can perform at least one function or operation. For example, these terms may refer to at least one piece of software stored in a memory or at least one piece of hardware, such as a Field Programmable Gate Array (FPGA) or an Application Specific Integrated Circuit (ASIC), or at least one process that is processed by a processor.

Reference numerals used in operations are provided for convenience of description, without describing the order of the operations, and the operations can be executed in an order different from the stated order unless a specific order is definitely specified in the context.

Hereinafter, embodiments of the disclosure will be described in detail with reference to the accompanying drawings.

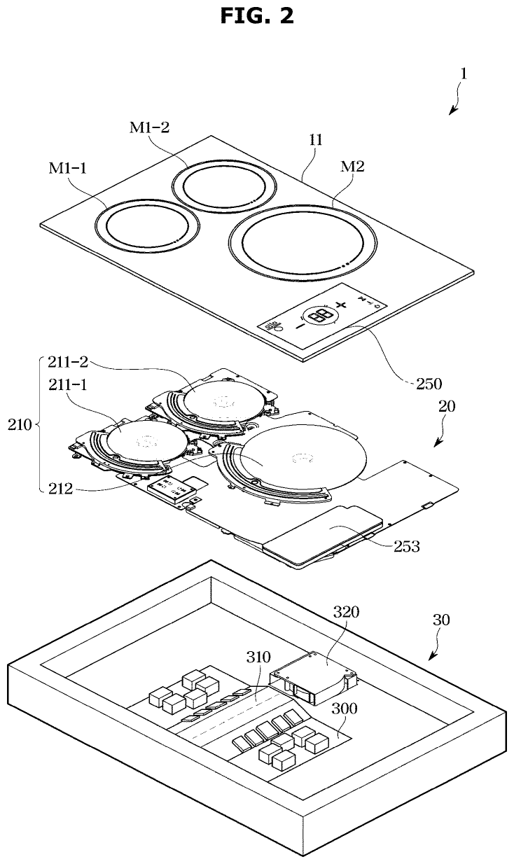

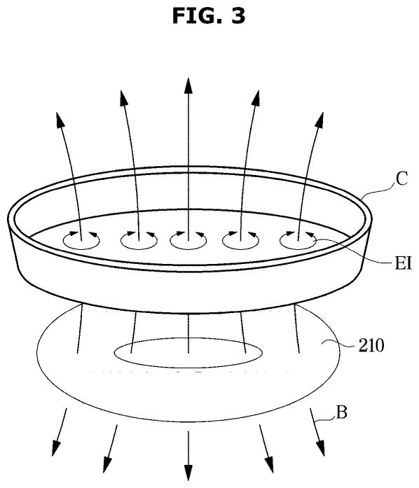

FIG. 1 is an external view of an induction heating apparatus according to an embodiment of the disclosure, FIG. 2 is a view illustrating an inside of an induction heating apparatus according to an embodiment of the disclosure, and FIG. 3 is a view illustrating a principle of heating a cooking vessel by an induction heating apparatus according to an embodiment of the disclosure.

Referring to FIG. 1, an induction heating apparatus 1 may include a main body 10 which forms an exterior of the induction heating apparatus 1 and is provided with various components constituting the induction heating apparatus 1.

An upper surface of the main body 10 may be provided with a cooking plate 11 having a flat plate shape on which a cooking vessel can be placed. The cooking plate 11 may be made of tempered glass such as ceramic glass so as not to be easily broken.

In this case, guide marks M1-1, M1-2, and M2 may be formed on the cooking plate 11 to guide a user where the cooking vessel can be heated. In the following description, the number of guide marks M corresponds to three, but the number of the guide marks M is not limited thereto, and any number of the guide marks M may be included without limitation.

In addition, one side of the cooking plate 11 may be provided with a user interface 250 for receiving a control command from the user and displaying operation information of the induction heating apparatus 1 to the user. However, a position of the user interface 250 is not limited to the cooking plate 11 and may be provided at various positions such as front and/or side surfaces of the main body 10.

Referring to FIG. 2, the induction heating apparatus 1 may be provided below the cooking plate 11 and include a heating layer 20 including a plurality of induction heating coils 210 (211-1, 211-2, and 212) for heating the cooking vessel placed on the cooking plate 11 and a main assembly 253 for implementing the user interface 250.

In this case, each of the induction heating coils 210 may be provided at a position corresponding to the guide marks M1-1, M1-2, and M2.

Particularly, the plurality of induction heating coils 210 may include one of the first induction heating coil 211-1, another one of the first induction heating coil 211-2, and one of the second induction heating coil 212.

In this case, a first induction heating coil 211 may be driven by an inverter circuit including one switching element, and the second induction heating coil 212 may be driven by the inverter circuit including a plurality of the switching elements (e.g., two (half bridge) and four (full bridge)).

Accordingly, the first induction heating coil 211 may output a lower power (e.g., 2.6 kW or less) than the second induction heating coil 212, and the second induction heating coil 212 may output a higher power (e.g., 3.6 kW or less) than the first induction heating coil 211. The description of the first induction heating coil 211 and the second induction heating coil 212 will be described later in detail.

FIG. 2 illustrates that two of the first induction heating coils 211 and one of the second induction heating coils 212 are provided. However, the present disclosure is not limited thereto, and the induction heating apparatus 1 may include at least one of the first induction heating coils 211 and at least one of the second induction heating coils 212.

That is, each of the number of the first induction heating coils 211 and the number of the second induction heating coils 212 included in the induction heating apparatus 1 may be included without limitation.

In addition, each of the plurality of induction heating coils 210 may generate a magnetic field and/or an electromagnetic field for heating the cooking vessel.

For example, when a driving current is supplied to the induction heating coil 210, as illustrated in FIG. 3, a magnetic field B may be induced around the induction heating coil 210.

In particular, when the induction heating coil 210 is supplied with a current whose magnitude and direction change with time, that is, an alternating current, the magnetic field B whose magnitude and direction change with time may be induced around the induction heating coil 210.

The magnetic field B around the induction heating coil 210 may pass through the cooking plate 11 made of tempered glass and may reach a cooking vessel C placed on the cooking plate 11.

Due to the magnetic field B that changes in magnitude and direction with time, an eddy current EI that rotates around the magnetic field B may occur in the cooking vessel C. As such, a phenomenon in which the eddy current occurs due to the magnetic field B that changes in time is called an electromagnetic induction phenomenon. Due to the eddy current EI, electrical resistance heat may be generated in the cooking vessel C. The electrical resistance heat is heat generated in a resistor when a current flows through the resistor, and is also called joule heat. The cooking vessel C may be heated by the electrical resistance heat, and food contained in the cooking vessel C may be heated.

As such, each of the plurality of induction heating coils 210 may heat the cooking vessel C using the electromagnetic induction phenomenon and the electrical resistance heat.

In addition, the heating layer 20 may be disposed under the user interface 250 provided on one side of the cooking plate 11, and may include the main assembly 253 for implementing the user interface 250.

The main assembly 253 may be a printed board assembly (PBA) including a display, the switching element, an integrated circuit element, etc. for implementing the user interface 250, and a printed circuit board (PCB) on which they are installed.

A position of the main assembly 253 is not limited to that illustrated in FIG. 2, and may be disposed at various positions. For example, when the user interface 250 is installed on a front surface of the main body 10, the main assembly 253 may be disposed behind the front surface of the main body 100 separately from the heating layer 20.

Under the heating layer 20, a driving layer 30 including a PBA 300 for implementing a circuit for supplying the driving current to the plurality of induction heating coils 210 may be provided.

As illustrated in FIG. 2, the driving layer 30 may include one of the PBAs 300 and a fan 320 for heat dissipation inside the driving layer 30. The one PBA 300 may include the switching element for supplying the driving current to the plurality of induction heating coils 210, a heat sink 310 for heat dissipation of the integrated circuit element, and the like.

For example, the one PBA 300 may be provided with at least one first driving circuit for supplying the driving current to the first induction heating coil 211, and at least one second driving circuit for supplying the driving current to the second induction heating coil 212, a power supply circuit for supplying power to at least one of the plurality of driving circuits, an electromagnetic interference (EMI) filter configured to block high frequency noise included in AC power input from the outside through the power supply circuit, and a rectifier circuit configured to rectify the supplied AC power.

In addition, the one PBA 300 may be provided with a vessel detecting circuit for detecting the presence of the cooking vessel C, a temperature detecting circuit for detecting a temperature of the cooking vessel C or a temperature of the heat sink 310, a protection circuit for blocking an overcurrent, and a controller for controlling the switching elements on the first and second driving circuits and receiving an output value from current detecting circuits on the first and second driving circuits.

As such, by installing the driving circuit, the power supply circuit, the EMI filter, the rectifier circuit, the detecting circuit, the protection circuit, and the controller in the one PBA, productivity and assembly in a manufacturing process of the induction heating apparatus 1 may be improved and material costs may be reduced.

In other words, the number of the PBAs may be reduced by installing the above components in the one PBA, and the number of connectors that need to connect different PBAs may be reduced, rather than manufacturing the controller including the driving circuit, the power supply circuit, the EMI filter, the rectifier circuit, the detecting circuit, the protection circuit, and at least one processor and at least one memory with the different PBAs, thereby improving productivity and assembly, and reducing material costs.

That is, when the controller including the driving circuit, the power supply circuit, the EMI filter, the rectifier circuit, the detecting circuit, the protection circuit, and the at least one processor and the at least one memory are each manufactured with the different PBAs, the number of the PBAs required for manufacturing of an apparatus is large, and the number of the connectors to be connected between a plurality of the PBAs is increased, resulting in poor assembly of the apparatus and higher material costs required for manufacturing of the apparatus.

Accordingly, the induction heating apparatus 1 may mount both the switching element and the integrated circuit capable of supplying the driving current to the induction heating coil 210 on the one PBA 300, thereby increasing the assembly and productivity of the apparatus and reducing the material costs required for the manufacture of the apparatus.

That is, since the detecting circuit, the driving circuit, and the power supply circuit are installed in the one PBA 300, the induction heating apparatus 1 may be easily manufactured and assembled, and the productivity may be improved.

In addition, the one PBA 300 may include both the first driving circuit including one of the switching elements and the second driving circuit including the plurality of switching elements, by adjusting the number of the first driving circuits and the second driving circuits according to the capacity of output power in a design stage of the induction heating apparatus 1, it is possible to provide the induction heating coil 210 for providing a variety of output power.

In this case, the number of the first driving circuits and the second driving circuits may correspond to the number of the first induction heating coils 211 and the number of the second induction heating coils 212, respectively. That is, each of the plurality of driving circuits may supply the driving current to the induction heating coil 210 electrically connected to one of the induction heating coils 210.

In detail, one of the first driving circuits may be electrically connected to one of the first induction heating coils 211, and the second driving circuit may be electrically connected to one of the second induction heating coils 212.

In other words, each of a plurality of driving circuits 150 and 160 included in the induction heating apparatus 1 may be connected to any one of the plurality of induction heating coils 210 to supply the driving current to the induction heating coils 210 connected thereto.

In the above, the structure and function of the induction heating apparatus 1 have been briefly described. Hereinafter, configurations of the induction heating apparatus 1 and a function of each of the configurations will be described in detail.

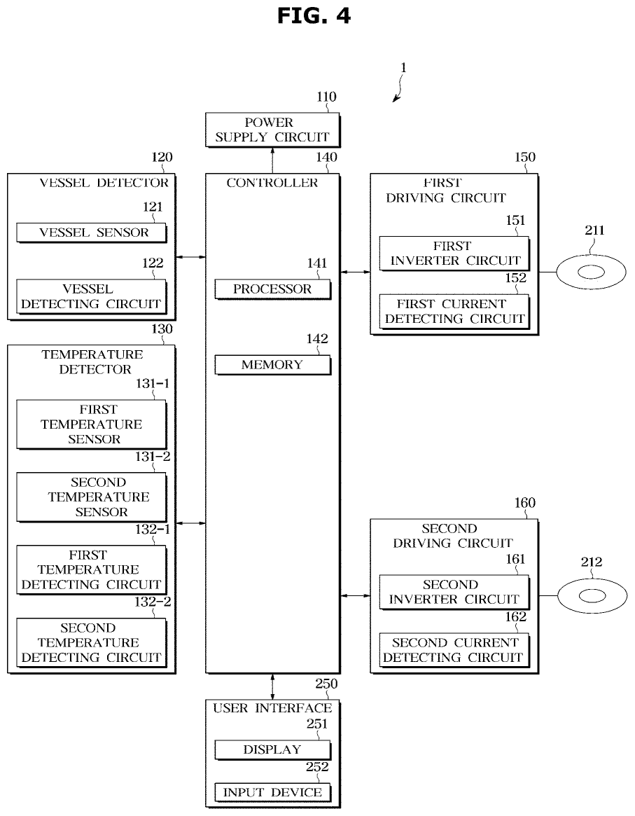

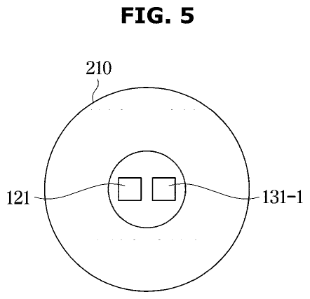

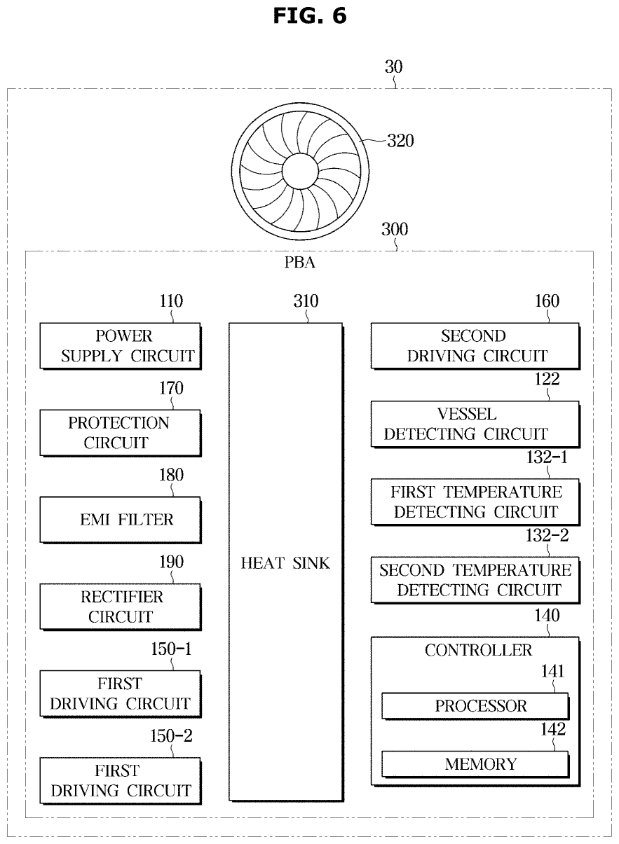

FIG. 4 is a control block diagram of an induction heating apparatus according to an embodiment of the disclosure, FIG. 5 is a view illustrating an induction heating coil, a vessel sensor, and a temperature sensor included in an induction heating apparatus according to an embodiment of the disclosure, and FIG. 6 is a view illustrating an example of an arrangement of a printed board assembly (PBA) included in an induction heating apparatus according to an embodiment of the disclosure.

Referring to FIG. 4, the induction heating apparatus 1 according to an embodiment may include a power supply circuit 110 configured to receive AC power from an external power source, a vessel detector 120 configured to detect the cooking vessel C placed on the cooking plate 11, a temperature detector 130 configured to detect the temperature of the cooking vessel C or the temperature of the heat sink 310 placed on the cooking plate 11, a controller 140 for controlling the induction heating apparatus 1 based on the user input, the first driving circuit 150 for supplying the driving current to the first induction heating coil 211, the second driving circuit 160 for supplying the driving current to the second induction heating coil 212, the plurality of induction heating coils 210 (211 and 212) arranged below the cooking plate 11 and configured to generate a magnetic field, and the user interface 250 for receiving an input from the user and displaying various messages.

Although FIG. 4 illustrates that the induction heating apparatus 1 includes one of the first driving circuit 150 and the second driving circuit 160, this is for convenience of description, and the induction heating apparatus 1 may include at least one of the first driving circuits 150 and at least one of the second driving circuits 160.

That is, the induction heating apparatus 1 may include the plurality of driving circuits 150 and 160. The first induction heating coil 211 and the second induction heating coil 212 may also be provided in a number corresponding to the number of the first driving circuits 150 and the second driving circuits 160, respectively. That is, the induction heating apparatus 1 may include the plurality of induction heating coils 210 having a number corresponding to the plurality of driving circuits 150 and 160.

The power supply circuit 110 may receive AC power from the external power source, and may supply the applied AC power to the driving circuits 150 and 160.

For example, the power supply circuit 110 may receive external AC power and convert the external AC power into three-phase AC power. The converted AC power may be supplied to the driving circuits 150 and 160 through the protection circuit, the EMI filter, and the rectifier circuit.

In this case, the power supply circuit 110 may be installed on the PBA 300 provided in the driving layer 30, as illustrated in FIG. 6.

The vessel detector 120 may detect the cooking vessel C placed on the cooking plate 11.

The vessel detector 120 may include a plurality of vessel sensors 121 for detecting the position of the cooking vessel C and a vessel detecting circuit 122 for processing outputs of the vessel sensors 121 and outputting information about the position of the cooking vessel C to the controller 140.

Each of the plurality of vessel sensors 121 may be installed near the plurality of induction heating coils 210, and may detect the cooking vessel C located on the adjacent induction heating coils 210. For example, as illustrated in FIG. 5, the vessel sensor 121 may be located at a center of the induction heating coil 210 and may detect the cooking vessel C located to overlap with the center of the induction heating coil 210. However, the position of the vessel sensor 121 is not limited to that illustrated in FIG. 5, and may be installed anywhere near the induction heating coil 210.

The vessel sensor 121 may include a capacitive sensor for detecting the cooking vessel C. Particularly, the vessel sensor 121 may detect a change in capacitance caused by the cooking vessel C. However, the vessel sensor 121 is not limited to the capacitive sensor, and includes various sensors capable of detecting the cooking vessel C placed on the cooking plate 11, such as an infrared sensor, a weight sensor, a micro switch, and a membrane switch.

The vessel sensor 121 may output information regarding the detection of the cooking vessel C to the vessel detecting circuit 122.

The vessel detecting circuit 122 may receive the detection results of the cooking vessel C from the plurality of vessel sensors 121, and may determine a position where the cooking vessel C is placed, particularly, the induction heating coil 210 overlapping the cooking vessel C, based on the detection results.

The vessel detecting circuit 122 may include a multiplexer for sequentially receiving the detection results from the plurality of vessel sensors 121, and a microprocessor for processing the detection results of the plurality of vessel sensors 121.

In addition, the vessel detecting circuit 122 may be installed in the one PBA 300 located in the driving layer 30, as illustrated in FIG. 6.

The vessel detecting circuit 122 may output vessel position data in which the detection results of the plurality of vessel sensors 121 are processed to the controller 140.

As such, the vessel detector 120 may determine the induction heating coil 210 overlapping the cooking vessel C, and may output the detection results to the controller 140. In this case, the controller 140 may control the user interface 250 to display the position of the cooking vessel C based on the detection results of the vessel detector 120, and may control the corresponding driving circuits 150 and 160 to supply the driving current to the induction heating coil 210 overlapping the cooking vessel C.

Optionally, the vessel detector 120 may be omitted, and the controller 140 may directly determine the induction heating coil 210 overlapping with the cooking vessel C.

For example, the controller 140 may determine the induction heating coil 210 overlapped with the cooking vessel C based on the change in inductance of the induction heating coil 210 by the approach of the cooking vessel C.

The controller 140 may control the plurality of driving circuits 150 and 160 to output a detecting signal for detecting the cooking vessel C to the plurality of induction heating coils 210 at predetermined times. In addition, the controller 140 may control current detecting circuits 152 and 162 of the plurality of driving circuits 150 and 160 to detect current flowing through each of the induction heating coils 210 by the detecting signal.

The inductance of the induction heating coil 210 overlapped with the cooking vessel C and the inductance of the induction heating coil 210 not occupied by the cooking vessel C are different from each other. For example, the inductance of the induction heating coil 210 overlapped with the cooking vessel C is greater than the inductance of the induction heating coil 210 not occupied by the cooking vessel C. This is because the inductance of the coil is proportional to permeability of the surrounding medium (particularly, center of the coil), since the permeability of the cooking vessel C is typically greater than the permeability of air.

In addition, an alternating current flowing in the induction heating coil 210 overlapped with the cooking vessel C is smaller than the alternating current flowing in the induction heating coil 210 not occupied by the cooking vessel C.

Accordingly, the controller 140 may measure the magnitude of the alternating current flowing through the induction heating coil 210 and compare the measured current with the reference current magnitude, thereby determining the induction heating coil 210 overlapped with the cooking vessel C. In detail, when the measured current is smaller than the reference current, the controller 140 may determine that the induction heating coil 210 overlaps the cooking vessel C.

However, the present disclosure is not limited thereto, and the induction heating apparatus 1 may determine the induction heating coil 210 overlapped with the cooking vessel C by measuring the frequency and phase of the alternating current flowing through the induction heating coil 210.

The temperature detector 130 may detect the temperature of the cooking vessel C or the temperature of the heat sink 310 placed on the cooking plate 11.

The cooking vessel C may be heated by the induction heating coil 210 and may be overheated depending on the material. Therefore, for safe operation, the induction heating apparatus 1 may detect the temperature of the cooking vessel C placed on the cooking plate 11 and block the operation of the induction heating coil 210 when the cooking vessel C is overheated.

To this end, the temperature detector 130 may include a plurality of first temperature sensors 131-1 for detecting the temperature of the cooking vessel C and a first temperature detecting circuit 132-1 for processing the output of the first temperature sensors 131-1 and outputting information about the temperature of the cooking vessel C to the controller 140.

Each of the plurality of first temperature sensors 131-1 may be installed near the plurality of induction heating coils 210 and measure the temperature of the cooking vessel C heated by the first induction heating coil 211. For example, as illustrated in FIG. 5, the first temperature sensors 131-1 may be located at the center of the first induction heating coil 211. The first temperature sensors 131-1 may directly measure the temperature of the cooking vessel C or measure the temperature of the cooking plate 11 capable of estimating the temperature of the cooking vessel C. However, the position of the first temperature sensor 131-1 is not limited to that illustrated in FIG. 5, and may be installed anywhere near the induction heating coil 210.

The first temperature sensors 131-1 may include a thermistor whose electrical resistance changes with the temperature.

The first temperature sensors 131-1 may output a signal indicating the temperature of the cooking vessel C to the first temperature detecting circuit 132-1.

The first temperature detecting circuit 132-1 may receive the signal indicating the temperature of the cooking vessel C from the plurality of first temperature sensors 131-1, and determine the temperature of the cooking vessel C from the received signal.

The first temperature detecting circuit 132-1 may include a multiplexer for sequentially receiving signals indicating the temperature from the plurality of first temperature sensors 131-1 and an analog-digital converter (ADC) for converting the signal indicating the temperature into digital temperature data.

In addition, the first temperature detecting circuit 132-1 may be installed on the PBA 300 provided in the driving layer 30, as illustrated in FIG. 6.

The first temperature detecting circuit 132-1 may process the signal indicating the temperature of the cooking vessel C output by the plurality of first temperature sensors 131-1, and may output temperature data to the controller 140.

As such, the temperature detector 130 may detect the temperature of the cooking vessel C and output the detection results to the controller 140. The controller 140 may determine whether the cooking vessel C is overheated based on the detection results of the temperature detector 130, and may stop the heating of the cooking vessel C when the cooking vessel C is overheated.

In addition, the heat sink 310 may be provided in the PBA 300, as illustrated in FIG. 6, and may be overheated by dissipating heat generated by a rectifier circuit 190 rectifying the AC power and the switching elements on the driving circuits 150 and 160.

In detail, the rectifier circuit 190 and the driving circuits 150 and 160 may be overheated according to the magnitude of the output power. Therefore, the heat sink 310 dissipating heat the rectifier circuit 190 and the driving circuits 150 and 160 may also be overheated.

Therefore, for safe operation, the induction heating apparatus 1 may detect the temperature of the heat sink 310 and block the operation of the induction heating coil 210 when the heat sink 310 is overheated.

To this end, the temperature detector 130 may include at least one second temperature sensor 131-2 for detecting the temperature of the heat sink 310 and a second temperature detecting circuit 132-2 for processing the output of the second temperature sensor 131-2 and outputting information about the temperature of the heat sink 310 to the controller 140.

The second temperature sensor 131-2 may be installed near the heat sink 310 and measure the temperature of the heat sink 310. To this end, the second temperature sensor 131-2 may include the thermistor whose electrical resistance changes with the temperature.

The second temperature sensor 131-2 may output the signal indicating the temperature of the heat sink 310 to the second temperature detecting circuit 132-2.

The second temperature detecting circuit 132-2 may receive the signal indicating the temperature of the heat sink 310 from the second temperature sensor 131-2, and may determine the temperature of the heat sink 310 from the received signal. In this case, the second temperature detecting circuit 132-2 may include the ADC for converting the signal indicating the temperature into the digital temperature data.

Also, as illustrated in FIG. 6, the second temperature detecting circuit 132-2 may be installed on the PBA 300 provided in the driving layer 30.

The second temperature detecting circuit 132-2 may process the signal indicating the temperature of the heat sink 310 output by the second temperature sensor 131-2, and may output the temperature data to the controller 140.

As such, the temperature detector 130 may detect the temperature of the heat sink 310 and output the detection results to the controller 140. The controller 140 may determine whether the heat sink 310 is overheated based on the detection results of the temperature detector 130, and may block the operation of the induction heating coil 210 when the heat sink 310 is overheated.

The controller 140 may collectively control the operation of the induction heating apparatus 1 according to the user input received through the user interface 250, and may include at least one processor 141 and at least one memory 142.

For example, the at least one processor 141 may generate an output control signal for controlling the strength of the magnetic field of the induction heating coil 210 according to an output level received from the user interface 250.

In detail, the at least one processor 141 may receive information about the induction heating coil 210 selected as a control target from among the plurality of induction heating coils 210 input from the user through the user interface 250.

In this case, the selected induction heating coil 210 may correspond to at least one of the second induction heating coil 212 having relatively high output power among the first induction heating coils 211 having relatively low output power.

In addition, the at least one processor 141 may receive information about the output level of the selected induction heating coil 210 input from the user through the user interface 250.

In this case, the at least one processor 141 may determine the strength (output power of the induction heating apparatus 1) of the magnetic field output by the induction heating coil 210 from the output level input by the user. To this end, a lookup table including the output power of the induction heating apparatus 1 corresponding to the output level of the user may be stored in the at least one memory 142 of the controller 140.

The at least one processor 141 may determine the output power of the induction heating apparatus 1 from the output level input by the user using the lookup table.

The at least one processor 141 may calculate a switching cycle (turn on / turn off frequency) of the switching element of a first inverter circuit 151 included in the first driving circuit 150 or the switching element of a second inverter circuit 161 included in the second driving circuit 160 from the output control signal indicative of the output level of the induction heating apparatus 1. The at least one processor 141 may generate a driving control signal for turning on/off the switching elements according to the calculated switching cycle.

The at least one processor 141 may control the switching elements included in each of the driving circuits 150 and 160 by transmitting the driving control signal to the first driving circuit 150 or the second driving circuit 160. Through this, the driving circuits 150 and 160 may control the driving current to be supplied to the induction heating coil 210.

That is, the at least one processor 141 may determine the magnitude of the AC driving current of at least one driving circuit corresponding to the induction heating coil 210 selected from the user among the plurality of driving circuits 150 and 160 based on information about the output of the induction heating apparatus 1 input from the user through the user interface 250 (e.g., information about the induction heating coil 210 selected as the control target among the plurality of induction heating coils 210, information about the output level of the selected induction heating coil 210).

In addition, the at least one processor 141 may determine the switching cycle of the switching element included in the at least one driving circuit based on the determined magnitude of the AC driving current, and may control each of the switching elements included in the at least one driving circuit based on the determined switching cycle.

The at least one processor 141 may generate an overheat prevention signal for cutting off power supplied to the driving circuits 150 and 160 according to the temperature of the cooking vessel C or the heat sink 310.

In detail, the at least one processor 141 may control the plurality of driving circuits 150 and 160 in a direction of reducing the magnitude of the driving current supplied to the plurality of induction heating coils 210 when the temperature of the cooking vessel C exceeds a predetermined temperature based on the output value of the first temperature detecting circuit 132-1.

In addition, the at least one processor 141 may control the plurality of driving circuits 150 and 160 in a direction of reducing the magnitude of the driving current supplied to the plurality of induction heating coils 210 when the temperature of the heat sink 310 exceeds the predetermined temperature based on the output value of the second temperature detecting circuit 132-2.

The at least one processor 141 may control the plurality of driving circuits 150 and 160 based on whether the cooking vessel C is placed on the induction heating coil 210 selected by the user through the user interface 250.

In detail, the at least one processor 141 may determine whether the cooking vessel C placed on the induction heating coil 210 corresponds to each of the plurality of driving circuits 150 and 160 based on the output values received from at least one of the vessel detecting circuit 122 and the current detecting circuits 152 and 162.

In this case, the at least one processor 141 may determine whether the cooking vessel C placed on the induction heating coil 210 corresponds to each of the plurality of driving circuits 150 and 160 by comparing the current value detected from the current detecting circuits 152 and 162 of each of the plurality of driving circuits 150 and 160 with a predetermined reference current value.

The at least one processor 141 may control the driving circuit corresponding to the selected induction heating coil 210 to supply the AC driving current to the selected induction heating coil 210 when the cooking vessel C is placed on the induction heating coil 210 selected by the user through the user interface 250.

When the cooking vessel C is not placed on the induction heating coil 210 selected by the user through the user interface 250, the at least one processor 141 may control the user interface 250 to output a message indicating that the cooking vessel C is not detected.

To this end, the at least one processor 141 may include various logic circuits and arithmetic circuits, and may process data according to a program provided from the at least one memory 142 and generate a control signal according to a processing result.

The at least one memory 142 may store a control program and control data for controlling the operation of the induction heating apparatus 1. In addition, the at least one memory 142 may be temporarily stored the user input received from the user interface 250, position data of the cooking vessel C received from the vessel detector 120, temperature data of the cooking vessel C or the heat sink 310 received from the temperature detector 130, and current values measured by the current detecting circuits 152 and 162 of the driving circuits 150 and 160.

In addition, the at least one memory 142 may provide a control program and/or control data to the at least one processor 141 according to the control signal of the at least one processor 141, or may provide the user input, the position data of the cooking vessel C, and/or the temperature data of the cooking vessel C or the heat sink 310 to the at least one processor 141.

To this end, the at least one memory 142 may include volatile memories such as static random access memory (S-RAM) and dynamic random access memory (D-RAM) for temporarily storing data, and non-volatile memories, for example, read only memory (ROM), erasable programmable read only memory (EPROM), electrically erasable programmable read only memory (EEPROM), and flash memory for storing data for a long period of time.

In addition, each of the at least one processor 141 and the at least one memory 142 may be implemented as a separate integrated circuit (IC), or may be integrally implemented as a single integrated circuit.

In addition, the at least one processor 141 and the at least one memory 142 may be installed on the PBA 300 provided in the driving layer 30, as illustrated in FIG. 6.

In addition, the at least one first driving circuit 150 and the at least one second driving circuit 160 may share the at least one processor 141 and the at least one memory 142. In other words, operations of the at least one first driving circuit 150 and the at least one second driving circuit 160 may be controlled by the at least one processor 141 and the at least one memory 142.

As such, the first driving circuit 150 and the second driving circuit 160 may selectively supply the driving currents to the plurality of induction heating coils 210 under the control of the controller 140.

That is, the first driving circuit 150 and the second driving circuit 160 may receive power from the external power source and supply the current to the induction heating coil 210 according to the driving control signal of the controller 140.

The first driving circuit 150 may supply the AC driving current to the first induction heating coil 211 using power supplied through the power supply circuit 110 under the control of the controller 140.

To this end, the first driving circuit 150 may include the first inverter circuit 151 for supplying or blocking the driving current to the first induction heating coil 211.

In this case, the first inverter circuit 151 may include one of the switching elements. The first inverter circuit 151 may turn off the switching element under the control of the controller 140 to block the supply of the driving current to the first induction heating coil 211. Alternatively, the first inverter circuit 151 may control the switching cycle of the switching element to vary the magnitude of the current supplied to the first induction heating coil 211.

That is, the first inverter circuit 151 may correspond to a single ended switching topology circuit for supplying the driving current to the first induction heating coil 211 using one of the switching elements.

In detail, the first inverter circuit 151 may include one resonant capacitor connected in parallel with the first induction heating coil 211 and the switching element provided between a resonant capacitor side node and a ground side node in series with the resonant capacitor.

In addition, the second driving circuit 160 may supply the AC driving current to the second induction heating coil 212 using power supplied through the power supply circuit 110 under the control of the controller 140.

To this end, the second driving circuit 160 may include the second inverter circuit 161 for supplying or blocking the driving current to the second induction heating coil 212.

In this case, the second inverter circuit 161 may include the plurality of switching elements. The second inverter circuit 161 may control the turn on/off of each of the plurality of switching elements under the control of the controller 140 to vary the magnitude and direction of the current supplied to the first induction heating coil 211.

That is, the second inverter circuit 161 may correspond to a half bridge circuit that supplies the driving current to the second induction heating coil 212 using two of the switching elements, and may correspond to a full bridge circuit that supplies the driving current to the second induction heating coil 212 using four of the switching elements.

In detail, the second inverter circuit 161 may correspond to a half bridge type circuit including a pair of the switching elements connected in series with each other and a pair of capacitors connected in series with each other, or may correspond to a full bridge type circuit including a pair of the switching elements connected in series with each other and the pair of other switching elements connected in series with each other.

When the second inverter circuit 161 corresponds to the half bridge type circuit, the pair of switching elements in the second inverter circuit 161 may be connected in parallel with the pair of capacitors, and one end of the second induction heating coil 212 may be connected to a node to which the pair of switching elements are connected in series and the other end of the second induction heating coil 212 may be connected to a node to which the pair of capacitors are connected in series.

In addition, when the second inverter circuit 161 corresponds to the full bridge type circuit, the pair of switching elements in the second inverter circuit 161 may be connected in parallel with the other pair of switching elements, and one end of the second induction heating coil 212 may be connected to the node to which the pair of switching elements are connected in series and the other end of the second induction heating coil 212 may be connected to a node to which the other pair of capacitors are connected in series.

As described above, the second inverter circuit 161 may supply higher power to the induction heating coil 210 using the plurality of switching elements, unlike the first inverter circuit 151.

Accordingly, the first induction heating coil 211 may output the lower power (e.g., 2.6 kW or less) than the second induction heating coil 212, and the second induction heating coil 212 may output the higher power (e.g., 3.6 kW or less) than the first induction heating coil 211.

In this case, since each of the switching elements included in each of the inverter circuits 151 and 161 is turned on/off at a high speed of 20 kHz to 70 kHz, the switching element may include a three-terminal semiconductor element switch having a fast response speed. For example, the switching element may be a bipolar junction transistor (BJT), a metal-oxide-semiconductor field effect transistor (MOST), an insulated gate bipolar transistor (IGBT), a thyristor, and the like.

The operation of the first inverter circuit 151 and the second inverter circuit 161 under the control of the controller 140 will be described in detail later.

In addition, the first driving circuit 150 may include the first current detecting circuit 152 for measuring the current output from the first inverter circuit 151, and the second driving circuit 160 may also include the second current detecting circuit 162 for measuring the current output from the second inverter circuit 161.

That is, the current detecting circuits 152 and 162 may detect the magnitude of the AC driving current supplied to the induction heating coil 210.

In order to adjust an amount of heat generated by the cooking vessel C by the magnetic field of the induction heating apparatus 1, the user may control the output of the induction heating apparatus 1 through the user interface 250. At this time, the amount of heat generated by the cooking vessel C may be controlled according to the strength of the magnetic field B output from the induction heating coil 210, and the strength of the magnetic field output by the induction heating coil 210 may be controlled according to the magnitude of current supplied to the induction heating coil 210. Therefore, the induction heating apparatus 1 may control the magnitude of the current supplied to the induction heating coil 210 in order to control the amount of heat generated by the cooking vessel C, and may measure the magnitude of the current supplied to the induction heating coil 210, that is, the magnitude of the current output from the inverter circuits 151 and 161 in order to control the magnitude of the current supplied to the induction heating coil 210.

In this case, the current detecting circuits 152 and 162 may include various circuits. For example, the current detecting circuits 152 and 162 may include a hall sensor for measuring the strength of the magnetic field generated around wires that supply the current to the induction heating coil 210, and may calculate the magnitude of the current output from the inverter circuits 151 and 161 based on the strength of one magnetic field measured by the hall sensor.

Each of the first driving circuit 150 and the second driving circuit 160 may be provided on the PBA 300 provided in the driving layer 30, as illustrated in FIG. 6.

In addition, although FIG. 4 illustrates that the first driving circuit 150 and the second driving circuit 160 are provided as one, the number of each of the first driving circuits 150 and the second driving circuits 160 is not limited thereto. The first driving circuit 150 and the second driving circuit 160 may each be provided in one or more numbers.

For example, as illustrated in FIG. 6, the induction heating apparatus 1 may be provided with a total of two of the first driving circuits 150 including one first driving circuit 150-1 and another first driving circuit 150-2 on the PBA 300, and may be provided with one of the second driving circuits 160 on the PBA 300.

Each of the driving circuits 150-1, 150-2, and 160 may be electrically connected to one of the induction heating coils 210 to supply the driving current to the connected induction heating coil 210. In this case, the induction heating apparatus 1 may correspond to a three-crater induction heating apparatus including a total of three craters, including two craters driven by the first driving circuits 150-1 and 150-2 and one crater driven by the second driving circuit 160.

However, the above example is merely an embodiment, and the first driving circuit 150 may be provided as one, and the second driving circuit 160 may be provided as two. In addition, each of the first driving circuit 150 and the second driving circuit 160 may be provided as one or two.

As such, the induction heating apparatus 1 may include the at least one first driving circuit 150 and the at least one second driving circuit 160. That is, the first driving circuit 150 and the second driving circuit 160 included in the induction heating apparatus 1 are not limited as long as they are one or more.

That is, the induction heating apparatus 1 may be provided with a plurality of the driving circuits having different switching topologies on the one PBA 300. By adjusting the number of the first driving circuits 150 and the second driving circuits 160 in accordance with the capacity of the output power in a design stage of the induction heating apparatus 1, it is possible to provide the induction heating coil 210 that provides various output power.

As described above, the plurality of induction heating coils 210 may generate the magnetic field and/or the electromagnetic field for heating the cooking vessel C placed on the cooking plate 11.

In this case, the plurality of induction heating coils 210 may include at least one of the first induction heating coils 211 and may include at least one of the second induction heating coils 212.

That is, unlike in FIG. 4, each of the number of the first induction heating coils 211 and the number of the second induction heating coils 212 included in the induction heating apparatus 1 may be included without limitation.

The first induction heating coil 211 may receive the driving current from the first driving circuit 150 including one of the switching elements, and the second induction heating coil 212 may be driven by the second driving circuit 160 including the plurality of switching elements (for example, two (half bridge) and four (full bridge)).

Accordingly, the first induction heating coil 211 may output the lower power (e.g., 2.6 kW or less) than the second induction heating coil 212, and the second induction heating coil 212 may output the higher power (e.g., 3.6 kW or less) than the first induction heating coil 211.

The user interface 250 is provided on the front surface of the main body 10, and may receive an output level selection command for adjusting the strength of the magnetic field generated by each of the induction heating coils 210 as well as control commands such as power input and start/stop of operation from the user.

The output level divides the strength of the magnetic field generated by each of the induction heating coils 210 discretely. Since the strength of the magnetic field corresponds to the strength of the current applied to the induction heating coil 210, the output level may be divided discretely from the strength of the current applied to the induction heating coil 210.

The output level may be divided into a plurality of levels, for example, may be divided into level 0 to level 10. In this case, the higher the output level, that is, the closer the output level is to level 10, the more the induction heating coil 210 may be set to generate a relatively large magnetic field. Accordingly, the cooking vessel C may be heated more quickly. Of course, according to a designer's selection, the lower the output level, the more the induction heating coil 210 may be set to generate a smaller magnetic field.

Each level may be defined by dividing the magnitude of the applied current at equal intervals. In other words, the difference in current between each level may be the same.

For example, level 0 may be an applied current of 0 A, and a difference in current corresponding to each of levels 1 to 10 may be defined as 1.6 A. In this case, level 10 may be defined as 16A. Of course, depending on the designer's selection, the current difference between the levels may be arbitrarily defined. Also, depending on the embodiment, the difference in current between the levels may not be the same. For example, some of the difference in current between levels may be greater than the difference in current between other levels.

The user interface 250 may include a display 251 for displaying an operation state of a cooking apparatus to the user and an input device 252 for receiving various control commands from the user.

The display 251 may be implemented by, for example, a liquid crystal display (LCD), a light emitting diode (LED), an organic light emitting diode (OLED), or the like.

The input device 252 may be implemented using various input devices such as a physical button, a touch button, a touch pad, a knob, a jog shuttle, an operation stick, a trackball, and a track pad.

In addition, the user interface 250 may include a touch screen panel (TSP) in which the display 251 and the input device 252 are integrally implemented.

The user interface 250 may receive a control command of the user who turns on/off the overall power of the induction heating apparatus 1 through the input device 252.

In addition, the user interface 250 may receive a selection of the induction heating coil to be controlled among the plurality of induction heating coils 210 provided in the induction heating apparatus 1 through the input device 252. In detail, the user may input a selection for the second induction heating coil 212 having a relatively high output power and a selection for the first induction heating coil 211 having a relatively low output power, through the input device 252.

In addition, the user interface 250 may input the output level of the selected induction heating coil 210 through the input device 252. In detail, the user may select the induction heating coil 210 to be controlled and input a control command to increase or decrease the output of the induction heating coil 210.

In addition, the user interface 250 may display the input output level of the induction heating coil 210 through the display 251 so that the user can recognize it, based on the control of the controller 140.

The induction heating apparatus 1 may further include a communication circuitry configured to be connected to a network by wire or wirelessly to communicate with another electronic device or a server.

The communication circuitry may exchange data with the server connected via a home server or with other electronic devices in the home. In addition, the communication circuitry may communicate data in accordance with the standards of the home server.

The communication circuitry may transmit and receive data related to a remote control through the network, and may transmit and receive information related to the operation of another electronic device. In addition, the communication circuitry may receive information about a life pattern of the user from the server and utilize the information for the operation of the induction heating apparatus 1. In addition, the communication circuitry may perform data communication with a user device (e.g., a portable terminal) as well as a server or a remote controller in the home.

That is, the communication circuitry may be connected to the network by wire or wirelessly to exchange data with the server, the remote controller, the user device, or another electronic device.

To this end, the communication circuitry may include one or more components in communication with other external electronic devices. For example, the communication circuitry may include a short-range communication module, a wired communication module, and a wireless communication module.

The short-range communication module may be a module for short-range communication within a predetermined distance. A short-range communication technology may include wireless local access network (WLAN), wireless fidelity (Wi-Fi), Bluetooth™, ZigBee™, Wi-Fi direct (WFD), ultra wideband (UWB), infrared data association (IrDA), Bluetooth low energy (BLE) or near field communication (NFC), and the like, but is not limited thereto.

The wired communication module may refer to a module for communication using an electrical signal or an optical signal. A wired communication technology may include a pair cable, a coaxial cable, an optical fiber cable, an Ethernet cable, and the like, but is not limited thereto.

The wireless communication module may transmit and receive a wireless signal with at least one of a base station, an external user device, and the server on a wireless communication network. The wireless signal may include various types of data according to transmission and reception of a voice call signal, a video call signal, or a text/multimedia message.

In the above, the components included in the induction heating apparatus 1 and the functions of the components are described. Hereinafter, the PBA 300 included in the induction heating apparatus 1 will be described in detail.

Referring to FIG. 6, the driving layer 30 may be provided with the fan 320 for heat dissipation inside the PBA 300 and the driving layer 30. In this case, the number and positions of the fans 320 are not limited to FIG. 6, and may be provided at various positions in various numbers according to embodiments.

The PBA 300 may include various components for driving the induction heating apparatus 1.

As described above, the power supply circuit 110, the vessel detecting circuit 122, the first temperature detecting circuit 132-1, the second temperature detecting circuit 132-2, the controller 140, and each of the first driving circuit 150 and the second driving circuit 160 of the induction heating apparatus 1 may be mounted on the one PBA 300.

At this time, as illustrated in FIG. 6, a total of two of the first driving circuits 150 including one of the first driving circuits 150-1 and another one of the first driving circuits 150-2 may be provided on the PBA 300, and the second driving circuit 160 may be provided on the PBA 300.

Each of the driving circuits 150-1, 150-2, and 160 may be electrically connected to one of the induction heating coils 210 to supply the driving current to the connected induction heating coil 210. In this case, the induction heating apparatus 1 may correspond to the three-crater induction heating apparatus including a total of three craters, including two craters driven by the first driving circuits 150-1 and 150-2 and one crater driven by the second driving circuit 160.

However, the above example is merely an embodiment, and the first driving circuit 150 may be provided as one, and the second driving circuit 160 may be provided as two. In addition, each of the first driving circuit 150 and the second driving circuit 160 may be provided as one or two.

As such, the at least one first driving circuit 150 and the at least one second driving circuit 160 may be installed on the PBA 300. That is, the number of the first driving circuits 150 and the second driving circuits 160 provided on the PBA 300 is not limited as long as the number is one or more.

In addition, a protection circuit 170, an EMI filter 180, and the rectifier circuit 190 may be installed on the PBA 300.

The protection circuit 170 may be provided between the power supply circuit 110 and the EMI filter 180 to block the overcurrent.

To this end, the protection circuit 170 may include at least one of a fuse and a relay.

However, the position where the protection circuit 170 is provided is not limited to the above example, and may be any position as long as it is a position capable of blocking the overcurrent on the entire circuit of the induction heating apparatus 1.

The EMI filter 180 may block high frequency noise (e.g., harmonics of AC power) included in AC power supplied from the external power supply through the power supply circuit 110, and may pass an alternating voltage and an alternating current of a predetermined frequency (e.g., 50 Hz or 60 Hz).

The EMI filter 180 may include an inductor and a capacitor provided between an input and an output of the filter. The inductor may block the passage of high frequency noise, and the capacitor may bypass the high frequency noise to the external power source.

In addition, the EMI filter 180 includes at least one of a common mode filter, a normal mode filter, an across the line capacitor (X-CAP), a line bypass capacitor (Y-CAP), and a varistor according to an embodiment.

The AC power in which high frequency noise is blocked by the EMI filter 180 may be supplied to the rectifier circuit 190.

The rectifier circuit 190 may convert AC power into DC power.

Particularly, the rectifier circuit 190 may convert an AC voltage whose magnitude and polarity (positive voltage or negative voltage) changes with time into a DC voltage having a constant magnitude and polarity, and may convert an AC current whose magnitude and direction (positive current or negative current) changes with time into a constant DC current.

To this end, the rectifier circuit 190 may include a bridge diode. For example, the rectifier circuit 190 may include four diodes. The diodes form two diode pairs in series, and the two diode pairs may be connected in parallel with each other. The bridge diode may convert the AC voltage whose polarity changes with time into a positive voltage with a constant polarity, and may convert the AC current whose direction changes with time into a positive current with a constant direction.

The rectified power through the rectifier circuit 190 may be applied to each of the driving circuits 150 and 160 and finally transmitted to the induction heating coil 210. In addition, the rectified power through the rectifier circuit 190 may be transmitted to each of the components that require power, such as the fan 320 and the controller 140.

In detail, an output terminal of the rectifier circuit 190 may be connected to the plurality of driving circuits 150 and 160. That is, the plurality of driving circuits 150 and 160 may be connected in parallel to the output terminals of the rectifier circuit 190.

In addition, the heat sink 310 may be installed on the PBA 300 to dissipate the circuits and the elements installed on the PBA 300.

Particularly, the heat sink 310 may be provided on the PBA 300, as illustrated in FIG. 6. The heat sink 310 may dissipate heat generated in at least one of the rectifier circuit 190 rectifying the AC power and the switching elements on the driving circuits 150 and 160.

To this end, the heat sink 310 may be provided in contact with at least one of the rectifier circuit 190 or the driving circuits 150 and 160 on the PBA 300. That is, the position of the heat sink 310 may be any position as long as it can be in contact with at least one of the rectifier circuit 190 and the driving circuits 150 and 160.

In addition, the heat sink 310 may be located on a surface or an inner layer of the PBA 300, and may correspond to a kind of metal plate, that is, a heat sink plate.

Each of the components illustrated as provided on the PBA 300 may be omitted according to the embodiment, and the order in which the respective components are arranged may be variously modified according to the embodiment.

As such, by installing the power supply circuit 110, the vessel detecting circuit 122 and first and second temperature detecting circuits 132-1, 132-2, the controller 140, the driving circuits 150 and 160, the protection circuit 170, the EMI filter 180, the rectifier circuit 190, and the like in the one PBA 300, productivity and assembly may be improved in the manufacturing process of the induction heating apparatus 1, and the material costs may be reduced.

In other words, rather than manufacturing the power supply circuit 110, the vessel detecting circuit 122 and first and second temperature detecting circuits 132-1, 132-2, the controller 140, the driving circuits 150 and 160, the protection circuit 170, the EMI filter 180, the rectifier circuit 190, and the like with different PBAs, installing the above components in the one PBA 300 may reduce the number of PBAs, and may reduce the number of the connectors that need to connect different PBAs, thereby improving the productivity and assembly, and reducing the material costs.

In addition, the one PBA 300 may include both the first driving circuit 150 including one of the switching elements and the second driving circuit 160 including the plurality of switching elements, thereby inducing the induction heating apparatus 1. By adjusting the number of the first driving circuits 150 and the second driving circuits 160 in accordance with the capacity of the output power in the design stage of the induction heating apparatus 1, it is possible to provide the induction heating coil 210 that provides various output power.

In the above, the PBA 300 included in the induction heating apparatus 1 has been described. Hereinafter, the circuit configuration of the induction heating apparatus 1 and the operation principle of the driving circuits 150 and 160 will be described in detail.

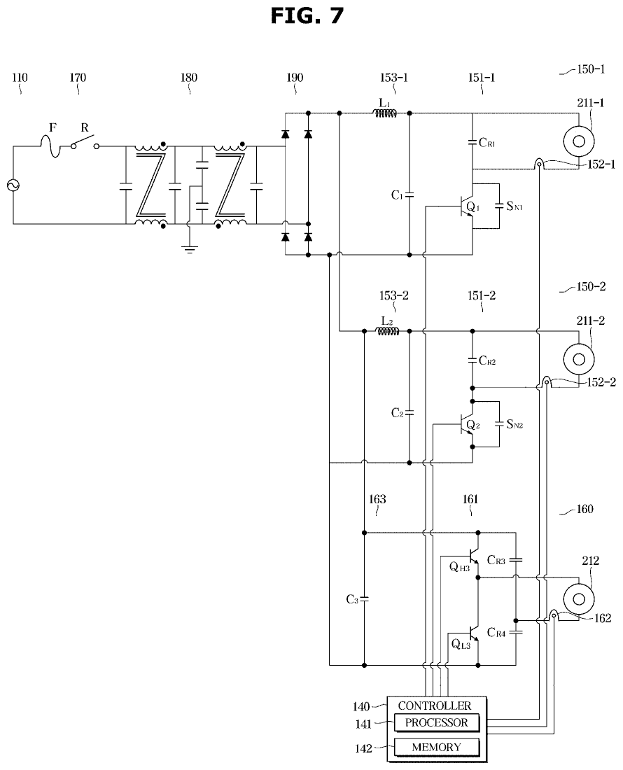

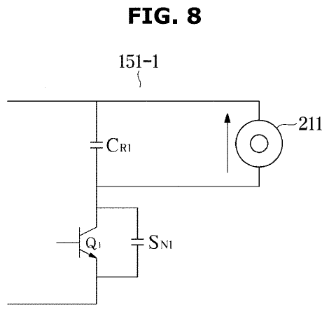

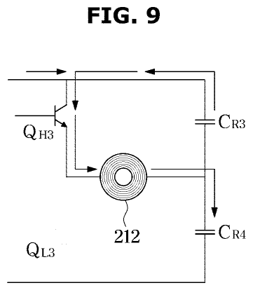

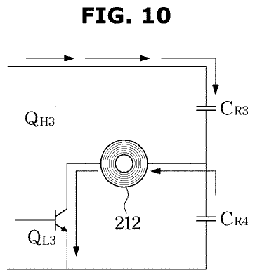

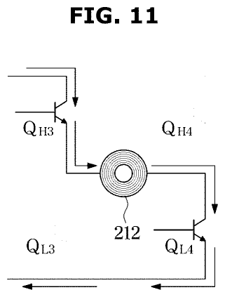

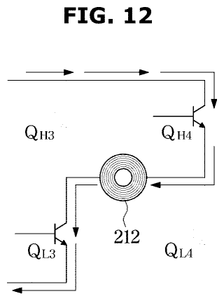

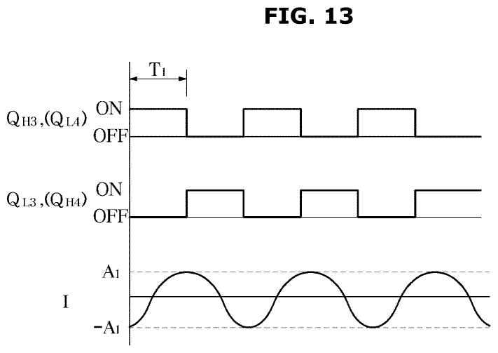

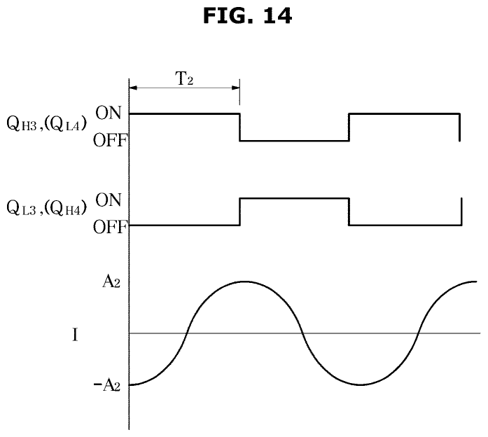

FIG. 7 is an example of a circuit diagram of an induction heating apparatus according to an embodiment of the disclosure, FIG. 8 is a view illustrating a first inverter circuit of a first driving circuit included in an induction heating apparatus according to an embodiment of the disclosure, FIGS. 9 and 10 are views illustrating current flow when a second inverter circuit of a second driving circuit according to an embodiment of the disclosure is a half bridge, FIGS. 11 and 12 are views illustrating current flow when a second inverter circuit of a second driving circuit according to an embodiment of the disclosure is a full bridge, and FIGS. 13 and 14 are views illustrating a magnitude of a current of an induction heating coil according to opening and closing periods of a second driving circuit included in an induction heating apparatus of the disclosure.

Referring to FIG. 7, the induction heating apparatus 1 may include two of the first driving circuits 150-1 and 150-2 and one of the second driving circuits 160.

In this case, each of the driving circuits 150-1, 150-2, and 160 may be electrically connected to one of the induction heating coils 210 to supply the AC driving current.

In detail, one of the first driving circuits 150-1 may be connected to one of the first induction heating coils 211-1, and the other first driving circuit 150-2 may be connected to the other first induction heating coil 211-2, and the second driving circuit 160 may be connected to the second induction heating coil 212.

That is, the induction heating apparatus 1 of the above example may correspond to the three-crater induction heating apparatus providing three craters.

However, the above example is merely an embodiment, and the first driving circuit 150 may be provided as one, and the second driving circuit 160 may be provided as two. In addition, each of the first driving circuit 150 and the second driving circuit 160 may be provided as one, or two each.

However, the above example is merely an embodiment, and the first driving circuit 150 may be provided as one, and the second driving circuit 160 may be provided as two. In addition, each of the first driving circuit 150 and the second driving circuit 160 may be provided as one or two.

As such, the at least one first driving circuit 150 and the at least one second driving circuit 160 may be installed on the PBA 300. That is, the number of the first driving circuits 150 and the second driving circuits 160 provided on the PBA 300 is not limited as long as the number is one or more.

That is, each of the plurality of driving circuits 150 and 160 included in the induction heating apparatus 1 may be configured to supply the driving current to the induction heating coil 210 connected to any one of the plurality of induction heating coils 210.

Hereinafter, for convenience of description, the induction heating apparatus 1 will be described as corresponding to the three-crater induction heating apparatus provided with two of the first driving circuits 150 and one of the second driving circuits 160.

The plurality of driving circuits 150-1, 150-2, and 160 included in the induction heating apparatus 1 may be connected to the rectifier circuit 190, respectively. That is, the plurality of driving circuits 150-1, 150-2, and 160 may be connected to each other in parallel with respect to the output terminal of the rectifier circuit 190, and each of the driving circuits 150-1, 150-2, and 160 may receive the power from the rectifier circuit 190.

In detail, the output terminal of the rectifier circuit 190 may be connected to the plurality of driving circuits 150-1, 150-2, and 160. That is, the plurality of driving circuits 150-1, 150-2, and 160 may be connected in parallel to the output terminal of the rectifier circuit 190.

At this time, as the power supplied to each of the driving circuits 150-1, 150-2, and 160 through the rectifier circuit 190 sequentially passes through the power supply circuit 110, the EMI filter 180, and the rectifier circuit 190, the power may correspond to a state in which high frequency noise is removed from the external power supply and rectified.

In addition, the induction heating apparatus 1 may further include the protection circuit 170 provided between the power supply circuit 110 and the EMI filter 180 to block the overcurrent. At this time, the protection circuit 170 may include at least one of a fuse F and a relay R.

Each of the plurality of driving circuits 150-1, 150-2, and 160 may include smoothing circuits 153-1, 153-2, and 163 for uniformly maintaining the DC power converted through the rectifier circuit 190. That is, the smoothing circuits 153-1, 153-2, and 163 may convert a positive voltage varying with time into the DC voltage having the constant magnitude, and may apply the converted DC voltage to the respective inverter circuits 151-1, 151-2, and 161.

In this case, each of the smoothing circuits 153-1, 153-2, and 163 may include capacitors C1, C2, and C3 connected in parallel to the output terminal of the rectifier circuit 190. The smoothing circuits 153-1 and 153-2 of the first driving circuits 150-1 and 150-2 may further include inductors L1 and L2 between an upper terminal of the rectifier circuit 190 and the capacitors C1 and C2 such that resonant capacitors CR1 and CR2 may resonate with the first induction heating coils 211-1 and 211-2.

Each of the plurality of driving circuits 150-1, 150-2, and 160 may include the inverter circuits 151-1, 151-1, and 161 which supply the AC driving current to the induction heating coils 211-1, 211-2, and 212.

One of the first inverter circuits 151-1 included in one of the first driving circuits 150-1 may have the same connection relationship between the configuration of the device and the other first inverter circuit 151-1 included in the other first driving circuit 150-2. For convenience of description, the first inverter circuit 151-1 will be described below.

As illustrated in FIG. 8, the first inverter circuit 151-1 of the first driving circuit 150-1 may include one of the resonance capacitors CR1 connected in parallel with the first induction heating coil 211, and a switching element Q1 provided between the resonant capacitor CR1 side node and the ground side node and connected in series with the resonant capacitor CR1. In addition, in the first inverter circuit 151-1, a surge suppressor SN1 may be connected in parallel.

In this case, the surge suppressor SN1 may include a capacitor and may further include a resistor according to the embodiment. As a result, the surge suppressor SN1 may suppress a surge or spark that may occur when the switching element Q1 is opened (turned off).

The switching element Q1 included in the first inverter circuit 151-1 may be opened or closed under the control of the controller 140. When the switching element Q1 is closed (turned on), the current may flow to the first induction heating coil 211 as illustrated in FIG. 8. In this case, the current passing through the first induction heating coil 211 may be transmitted to the resonant capacitor CR1 to charge the resonant capacitor CR1.

Then, when the switching element Q1 is opened (turned off), the charge stored in the resonant capacitor CR1 is discharged, the current may flow on the first induction heating coil 211, and the current passing through the first induction heating coil 211 may again charge the resonant capacitor CR1.

As such, when the switching element Q1 is opened, the resonance capacitor CR1 and the first induction heating coil 211 may resonate, and in the first induction heating coil 211, the AC driving current having different direction and magnitude depending on the time may flow.

Through this, the magnetic field may be generated on the first induction heating coil 211, and the cooking vessel C may be heated based on the magnetic field of the first induction heating coil 211.

In this case, the controller 140 may determine the switching cycle of the switching element Q1 corresponding to the output level input through the user interface 250, and may control to open or close the switching element Q1 based on the determined switching cycle.

Particularly, as the output level is increased, the switching cycle of the switching element Q1 may become longer. As a result, as the amount of charge charged in the resonant capacitor CR1 increases, the AC driving current having a high peak point may be provided on the first induction heating coil 211.

In addition, the controller 140 may shorten the switching cycle of the switching element Q1 over time to prevent the magnitude of the AC driving current provided on the first induction heating coil 211 from exceeding a threshold current magnitude.

The second inverter circuit 161 of the second driving circuit 160 may correspond to the half bridge type circuit, as illustrated in FIGS. 7, 9, and 10.

Particularly, when the second driving circuit 160 corresponds to the half bridge type circuit, the second driving circuit 160 may include a pair of switching elements QH3 and QL3 connected in series with each other and a pair of resonance capacitors CR3 and CR4 connected in series with each other.

At this time, the pair of switching elements QH3 and QL3 may be connected in parallel with the pair of resonant capacitors CR3 and CR4, and one end of the second induction heating coil 212 may be connected to a node to which the pair of switching elements QH3 and QL3 are connected in series and the other end of the second induction heating coil 212 may be connected to a node to which the pair of resonant capacitors CR3 and CR4 are connected in series.

The first switching element QH3 and the second switching element QL3 included in the pair of switching elements QH3 and QL3 may be closed (turned on) or opened (turned off) under the control of the controller 140.

In addition, according to the turning on/off of the first switching element QH3 and the second switching element QL3, the driving current may flow through the first switching element QH3 and/or the second switching element QL3 to the second induction heating coil 212, or the driving current may flow from the second induction heating coil 212 through the first switching element QH3 and/or the second switching element QL3.

For example, as illustrated in FIG. 9, when the first switching element QH3 is closed (turned on) and the second switching element QL3 is opened (turned off), the current may flow through the first switching element QH3 to the second induction heating coil 212.

In addition, as illustrated in FIG. 10, when the first switching element QH3 is opened (turned off) and the second switching element QL3 is closed (turned on), the current may flow from the second induction heating coil 212 through the second switching element QL3.

The pair of resonant capacitors CR3 and CR4 may include the first resonant capacitor CR3 and the second resonant capacitor CR4. The first resonant capacitor CR3 and the second resonant capacitor CR4 may be connected in series between a positive line and a negative line.

According to the opening and closing of the first switching element QH3 and the second switching element QL3, a current may be output from the first resonant capacitor CR3 and/or the second resonant capacitor CR4 to the second induction heating coil 212, and the current may be input from the second induction heating coil 212 to the first resonant capacitor CR3 and/or the second resonant capacitor CR4.

For example, as illustrated in FIG. 9, when the first switching element QH3 is closed (turned on) and the second switching element QL3 is opened (turned off), the current may be supplied from the second induction heating coil 212 to the first resonant capacitor CR3 and/or the second resonant capacitor CR4.

In addition, as illustrated in FIG. 10, when the first switching element QH3 is opened (turned off) and the second switching element QL3 is closed (turned on), the current may be supplied from the first resonant capacitor CR3 and/or the second resonant capacitor CR4 to the second induction heating coil 212.

As such, the second inverter circuit 161 may control the current supplied to the second induction heating coil 212. In detail, the magnitude and direction of the current flowing in the second induction heating coil 212 may vary according to the opening and closing of the first switching element QH3 and the second switching element QL3 included in the second inverter circuit 161. In other words, the AC current may be supplied to the second induction heating coil 212.

For example, as illustrated in FIG. 9, when the first switching element QH3 is closed (turned on) and the second switching element QL3 is opened (turned off), the current supplied from the rectifier circuit 190 may be supplied to the second induction heating coil 212 through the first switching element QH3. The current supplied to the second induction heating coil 212 may be supplied to the second resonant capacitor CR4 through the second induction heating coil 212, and electrical energy may be stored in the second resonant capacitor CR4. In this case, a positive current (current flowing from a left side to a right side of the second induction heating coil 212 in FIG. 9) may flow in the second induction heating coil 212. In addition, as the electrical energy is stored in the second resonant capacitor CR4, the current may be supplied from the first resonant capacitor CR3 to the second induction heating coil 212 through the first switching element QH3.

In addition, as illustrated in FIG. 10, when the first switching element QH3 is opened (turned off) and the second switching element QL3 is closed (turned on), the current may be supplied from the second resonant capacitor CR4 to the second induction heating coil 212. The current supplied to the second induction heating coil 212 may flow to the rectifier circuit 190 through the second induction heating coil 212 and the second switching element QL3. In this case, a negative current (current flowing from the right side to the left side of the second induction heating coil 212 in FIG. 10) may flow in the second induction heating coil 212. In addition, since the current is output from the second resonant capacitor CR4, the electrical energy stored in the second resonant capacitor CR4 may be reduced, and the current may be supplied from the rectifier circuit 190 to the first resonant capacitor CR3.

The second inverter circuit 161 of the second driving circuit 160 may correspond to the full bridge type circuit, as illustrated in FIG. 7.

Particularly, when the second driving circuit 160 corresponds to the full bridge type circuit, as illustrated in FIGS. 11 and 12, the second driving circuit 160 may include the pair of switching elements QH3 and QL3 connected in series with each other and another pair of switching elements QH4 and QL4 connected in series with each other.

At this time, the pair of switching elements QH3 and QL3 may be connected in parallel with the other pair of switching elements QH4 and QL4, and one end of the second induction heating coil 212 may be connected to a node to which the pair of switching elements QH3 and QL3 are connected in series and the other end of the second induction heating coil 212 may be connected to a node to which the other pair of switching elements QH4 and QL4 are connected in series.

The first switching element QH3 and the second switching element QL3 included in the pair of switching elements QH3 and QL3 may be closed (turned on) or opened (turned off) under the control of the controller 140.

In addition, the third switching element QH4 and the fourth switching element QL4 included in the other pair of switching elements QH4 and QL4 may also be closed (turned on) or opened (turned off) under the control of the controller 140.

According to the turn-on/turn-off of the first switching element QH3 to the fourth switching element QL4, the magnitude and direction of the driving current supplied to the second induction heating coil 212 may change with time.

For example, as illustrated in FIG. 11, when the first switching element QH3 and the fourth switching element QL4 are closed (turned on), and the second switching element QL3 and the third switching element QH4 are closed (turned off), the current may flow through the first switching element QH3 to the second induction heating coil 212.

In addition, as illustrated in FIG. 12, when the first switching element QH3 and the fourth switching element QL4 are opened (turned off), and the second switching element QL3 and the third switching element QH4 are closed (turned on), the current may flow through the third switching element QH4 to the second induction heating coil 212.

As such, the second inverter circuit 161 may control the current supplied to the second induction heating coil 212. In detail, the magnitude and direction of the current flowing in the second induction heating coil 212 may vary according to the opening and closing of the first switching element QH3 and the fourth switching element QL4 included in the second inverter circuit 161. In other words, the AC current may be supplied to the second induction heating coil 212.

For example, as illustrated in FIG. 11, when the first switching element QH3 and the fourth switching element QL4 are closed (turned on) and the second switching element QL3 and the third switching element QH4 are opened (turned off), the current supplied from the rectifier circuit 190 may be supplied to the second induction heating coil 212 through the first switching element QH3. The current supplied to the second induction heating coil 212 may be supplied to the fourth switching element QL4 through the second induction heating coil 212. In this case, the positive current (current flowing from the left side to the right side of the second induction heating coil 212 in FIG. 11) may flow in the second induction heating coil 212.

In addition, as illustrated in FIG. 12, when the first switching element QH3 and the fourth switching element QL4 are opened (turned off) and the second switching element QL3 and the third switching element QH4 are closed (turned on), the current supplied from the rectifier circuit 190 may be supplied to the second induction heating coil 212 through the third switching element QH4. The current supplied to the second induction heating coil 212 may flow to the rectifier circuit 190 through the second induction heating coil 212 and the second switching element QL3. In this case, the negative current (current flowing from the right side to the left side of the second induction heating coil 212 in FIG. 12) may flow in the second induction heating coil 212.

Thus, in the second driving circuit 160, according to the switching cycle of the first switching element QH3 and the second switching element QL3 (when the second inverter circuit 161 corresponds to the half bridge type circuit) or the switching cycle of the first switching element QH3 to the fourth switching element QL4 (when the second inverter circuit 161 corresponds to the full bridge type circuit), the magnitude of the current supplied to the second induction heating coil 212 may vary and the strength of the magnetic field output by the second induction heating coil 212 may vary.

To this end, the controller 140 may determine the switching cycles of the first switching element QH3 and the second switching element QL3 corresponding to the output level input through the user interface 250 or the switching cycles of the first switching element QH3 to the fourth switching element QL4. The controller 140 may control to open or close the first switching element QH3 and the second switching element QL3 based on the determined switching cycles, or may control to open and close the first switching element QH3 to the fourth switching element QL4.

For example, when the second inverter circuit 161 corresponds to the half bridge type circuit, as illustrated in FIG. 13, and when the first switching element QH3 is closed (turned on) and the second switching element QL3 is opened (turned off), the current supplied to the second induction heating coil 212 (the current flowing in the second induction heating coil 212) may increase from the negative current to the positive current.

In this case, the current I supplied to the second induction heating coil 212 may increase to a first amplitude A1 during a first time T1. After the first time T1 has elapsed, when the first switching element QH3 is opened (turned off) and the second switching element QL3 is closed (turned on), the current supplied to the second induction heating coil 212 may decrease from the positive current to the negative current.

In addition, as illustrated in FIG. 14, when the first switching element QH3 is closed (turned on) and the second switching element QL3 is opened (turned off), the current supplied to the second induction heating coil 212 (current flowing in the second induction heating coil 212) may increase from the negative current to the positive current.

At this time, the current I supplied to the second induction heating coil 212 may increase for a second time T2 greater than the first time T1, and the current supplied to the second induction heating coil 212 may increase to a second amplitude A2 that is greater than the first amplitude A1. After the second time T2 has elapsed, when the first switching element QH3 is opened (turned off) and the second switching element QL3 is closed (turned on), the current supplied to the second induction heating coil 212 may decrease from the positive current to the negative current.

As such, a sinusoidal alternating current may be supplied to the second induction heating coil 212 according to the switching operation of the first switching element QH3 and the second switching element QL3. In addition, the longer the switching cycle of the first switching element QH3 and the second switching element QL3, that is, the smaller the switching frequency of the first switching element QH3 and the second switching element QL3, the more increased the current supplied to the second induction heating coil 212 may be, and the strength (output of the induction heating apparatus 1) of the magnetic field output by the second induction heating coil 212 may be increased.

In addition, when the second inverter circuit 161 corresponds to the full bridge type circuit, as illustrated in FIGS. 13 and 14, the controller 140 may equally control the opening and closing operations of each of the first switching element QH3 and the fourth switching element QL4, and may equally control the opening and closing operations of each of the second switching element QL3 and the third switching element QH4.

In this way, the controller 140 may determine the strength of the magnetic field output by the second induction heating coil 212 by determining the switching cycles of the first switching element QH3 and the second switching element QL3 corresponding to the output level input through the user interface 250.

In addition, each of the plurality of driving circuits 150-1, 150-2, and 160 may include the current detecting circuits 152-1, 152-2, and 162 that measure the current output from the inverter circuits 151-1, 151-2, and 161.

Particularly, the first driving circuits 150-1 and 150-2 may include the first current detecting circuits 152-1 and 152-2 for measuring the current output from the first inverter circuits 151-1 and 151-2. The second driving circuit 160 may also include the second current detecting circuit 162 for measuring the current output from the second inverter circuit 161.

That is, the current detecting circuits 152-1, 152-2, and 162 may detect the magnitude of the AC driving current supplied to the induction heating coils 211-1, 211-2, and 212.

In this case, the controller 140 may be electrically connected to each of the current detecting circuits 152-1, 152-2, and 162. The controller 140 may control each of the current detecting circuits 152-1, 152-2, and 162 to detect the magnitude of the current supplied to the induction heating coils 211-1, 211-2, and 212, and may receive information about the magnitude of the current supplied to the induction heating coils 211-1, 211-2, and 212 output from each of the current detecting circuits 152-1, 152-2, and 162.

As described above, the controller 140 may determine whether there is the cooking vessel C based on the output values of the current detecting circuits 152 and 162, and may determine whether the induction heating apparatus 1 has failed by determining whether the intended current flows on the induction heating coil 210.

According to the induction heating apparatus of the exemplary embodiments, by including a plurality of inverters configured with a plurality of types of switching topologies on the PBA, it is possible to provide the induction heating apparatus with reduced material costs and improved productivity.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be read only memory (ROM), random access memory (RAM), a magnetic tape, a magnetic disc, flash memory, an optical data storage device, etc.

Although the present disclosure has been described with various embodiments, various changes and modifications may be suggested to one skilled in the art. It is intended that the present disclosure encompass such changes and modifications as fall within the scope of the appended claims.

What is claimed is:

1. An induction heating apparatus comprising:
a cooking plate;
a plurality of induction heating coils installed below the cooking plate and configured to generate a magnetic field;
a plurality of driving circuits respectively connected to the plurality of induction heating coils, each of the plurality driving circuits configured to supply a driving current to the respective induction heating coil; and
a rectifier circuit configured to rectify AC power and supply the rectified AC power to the plurality of driving circuits,
wherein the plurality of driving circuits are connected in parallel to an output terminal of the rectifier circuit,
wherein the plurality of driving circuits comprise:
a first driving circuit comprising a first switching element, and
a second driving circuit comprising a plurality of switching elements.

2. The induction heating apparatus according to claim 1, wherein the first driving circuit further comprises one first capacitor connected in parallel with the induction heating coil,
wherein the first switching element is provided between a first capacitor side node and a ground side node, the first switching element connected in series with the first capacitor.

3. The induction heating apparatus according to claim 1, wherein the second driving circuit corresponds to:
a half bridge type circuit including:
a pair of switching elements of the plurality of switching elements connected in series with each other, and
a pair of capacitors connected in series with each other; or
a full bridge type circuit including:
a pair of switching elements of the plurality of switching elements connected in series with each other, and
another pair of switching elements of the plurality of switching elements connected in series with each other.

4. The induction heating apparatus according to claim 3, wherein, when the second driving circuit corresponds to the half bridge type circuit:
the pair of switching elements are connected in parallel with the pair of capacitors; and
one end of the induction heating coil is connected to a node to which the pair of switching elements are connected in series and another end of the induction heating coil is connected to a node to which the pair of capacitors are connected in series.

5. The induction heating apparatus according to claim 3, wherein, when the second driving circuit corresponds to the full bridge type circuit:
the pair of switching elements are connected in parallel with the other pair of switching elements; and
one end of the induction heating coil is connected to a node to which the pair of switching elements are connected in series and another end of the induction heating coil is connected to a node to which another pair of capacitors are connected in series.

6. The induction heating apparatus according to claim 1, wherein each of the plurality of driving circuits comprises a smoothing circuit configured to uniformly maintain the rectified AC power from the rectifier circuit.

7. The induction heating apparatus according to claim 1, further comprising a power supply circuit configured to receive the AC power from an external power source.

8. The induction heating apparatus according to claim 7, further comprising an electromagnetic interference (EMI) filter provided between the power supply circuit and the rectifier circuit and configured to block high frequency noise included in the AC power.

9. The induction heating apparatus according to claim 1, further comprising a user interface configured to receive information about an output of the induction heating apparatus from a user.

10. The induction heating apparatus according to claim 9, further comprising a processor configured to:
determine a magnitude of an AC driving current transmitted to a driving circuit of the plurality of driving circuits based on the information about the output of the induction heating apparatus;
determine a switching cycle of a switching element included in the driving circuit based on the determined magnitude of the AC driving current; and
open or close the switching element based on the determined switching cycle.

11. The induction heating apparatus according to claim 10, further comprising:
a first temperature sensor configured to detect a temperature of a cooking vessel placed on the cooking plate; and
a first temperature detecting circuit configured to transmit an output of the first temperature sensor to the processor.

12. The induction heating apparatus according to claim 11, wherein, when the temperature of the cooking vessel exceeds a predetermined temperature, the processor is further configured to control the plurality of driving circuits in a direction of reducing the magnitude of the AC driving current supplied to the plurality of induction heating coils.

13. The induction heating apparatus according to claim 10, further comprising a heat sink provided in contact with at least one of the rectifier circuit or the plurality of driving circuits.

14. The induction heating apparatus according to claim 13, further comprising:
a second temperature sensor configured to detect a temperature of the heat sink; and
a second temperature detecting circuit configured to transmit an output of the second temperature sensor to the processor.

15. The induction heating apparatus according to claim 14, wherein, when the temperature of the heat sink exceeds a predetermined temperature, the processor is further configured to control the plurality of driving circuits in a direction of reducing the magnitude of the AC driving current supplied to the plurality of induction heating coils.

16. The induction heating apparatus according to claim 10, further comprising:
a vessel sensor configured to detect whether a cooking vessel is placed on the cooking plate; and
a vessel detecting circuit configured to transmit an output of the vessel sensor to the processor.

17. The induction heating apparatus according to claim 16, wherein each of the plurality of driving circuits further comprises a current detecting circuit configured to detect the magnitude of the AC driving current supplied to the respective induction heating coil.

18. The induction heating apparatus according to claim 17, wherein the processor is further configured to determine whether the cooking vessel is placed on the induction heating coil corresponding to each of the plurality of driving circuits based on a value of the output received from at least one of the vessel detecting circuit and the current detecting circuit.

19. The induction heating apparatus according to claim 18, wherein the processor is further configured to determine whether the cooking vessel is placed on the induction heating coil corresponding to each of the plurality of driving circuits by comparing a current value detected from the current detecting circuit of each of the plurality of driving circuits with a predetermined reference current value.

20. The induction heating apparatus according to claim 18, wherein, when the cooking vessel is placed on an induction heating coil selected by the user through the user interface, the processor is further configured to control the driving circuit corresponding to the induction heating coil selected by the user to supply the AC driving current to the induction heating coil selected by the user.
